(19) United States
(12) Patent Application Publication
(10) Pub. No.: US 2025/0131856 A1
(43) Pub. Date: Apr. 24, 2025

(54) TRADING CARD DISPLAY SYSTEMS, DEVICES AND METHODS

(71) Applicant: Peter Pavlow, Caldwell, NJ (US)

(72) Inventor: Peter Pavlow, Caldwell, NJ (US)

(21) Appl. No.: 18/892,802

(22) Filed: Sep. 23, 2024

Related U.S. Application Data
(60) Provisional application No. 63/592,237, filed on Oct. 23, 2023.

(51) Int. Cl. G09F 1/12; G09F 15/00

(52) U.S. Cl. CPC G09F 1/12; G09F 15/0018

(57) ABSTRACT

The Magnetic Trading Card Display Board is designed to enhance the organization, preservation, and visual presentation of trading cards. This innovative display system features multiple conforming squares, each equipped with four embedded magnets that align with the screws of standard trading card display holders, ensuring secure and stable attachment. The board can be fabricated from various materials such as paper, cardboard, acrylic, and wood, and can be mounted using adhesive methods for easy installation. This system allows for effortless attachment, detachment, and rearrangement of trading cards, providing a versatile and user-friendly solution for collectors and enthusiasts.

### CROSS REFERENCE TO RELATED APPLICATIONS

This application claims the benefit of U.S. Provisional Patent Application No. 63/592,237, filed on Oct. 23, 2023, titled “MAGNETIC TRADING CARD DISPLAY BOARD,” the entire contents of which are incorporated by reference herein.

### TECHNICAL FIELD

The present disclosure relates to trading card display systems, specifically designed to enhance the organization, preservation, and visual presentation of trading cards. These systems are tailored for collectors and enthusiasts who wish to showcase their collections in an aesthetically pleasing and accessible manner while ensuring the protection and longevity of the cards. Features may include modular display units, protective casings, adjustable stands, and integrated lighting, catering to various types of trading cards, including sports, gaming, and collectible cards. Additionally, the disclosure addresses solutions for easy rearrangement and customization of displays, accommodating different collection sizes and personal preferences. This innovative display board is designed to overcome the limitations of current display methods, providing a versatile and user-friendly option for collectors.

### BACKGROUND

### Description of Related Art

Existing trading card display cases are fraught with several significant drawbacks, which this disclosure aims to overcome. The conventional display cases are often bulky and heavy, making them difficult to handle and mount on walls. Additionally, they tend to have a cumbersome design, which complicates the process of accessing and organizing the displayed items. These traditional display systems are typically limited in terms of aesthetic appeal, often failing to enhance the visual presentation of the collectibles.

Many collectors resort to using frames, boxes, or shelves to showcase their trading cards, photographs, or other collectibles, but these methods frequently result in a cluttered and unorganized display. Furthermore, the lack of flexibility in repositioning or rearranging the items without significant effort discourages collectors from updating their displays regularly.

The market currently lacks a display solution that seamlessly integrates functionality, ease of use, and aesthetic appeal. Collectors seek a method that not only securely holds their items but also allows for easy modifications and enhances the visual impact of their collections. The need for an innovative display board that addresses these issues is evident.

### SUMMARY

The present disclosure introduces a novel display device, system, and method for the effortless and convenient exhibition of one or more items, such as trading cards, photographs, and similar collectibles. The core innovation lies in the use of standard protective trading card display holders, each equipped with four (4) screws positioned at the corners, which are magnetically mounted on a specially designed trading card display board.

This display board is crafted with numerous conforming squares, each square meticulously designed to accommodate trading card holders. Strategic placement of magnets within the four (4) corners of each square that align perfectly with the four (4) metallic screws of the standard trading card display board ensuring a secure and stable mount for the card holders. This design allows collectors to easily attach, detach, and rearrange their items without the need for additional tools or complicated procedures.

The magnetic trading card display board offers a sleek and modern solution that enhances the visual presentation of the collectibles. It combines functionality with aesthetics, providing a lightweight, easy-to-mount, and flexible display option. Collectors can now effortlessly organize and showcase their prized possessions, making the display board an indispensable addition to any collection.

### DETAILED DESCRIPTION

### Components

1. Display Board (100): The display board (100) serves as the foundational element of the system, providing a surface (200) for the arrangement and display of trading cards, photographs, and similar collectibles. The board (100) can be crafted from a variety of materials to suit different aesthetic preferences and functional requirements, including but not limited to:
   Paper: Lightweight and economical, ideal for temporary displays or mass production.
   Poster Board: Slightly more durable than paper, providing a cost-effective solution for semi-permanent displays.
   Cardboard: Offers sturdiness and ease of customization, suitable for hobbyists and craft projects.
   Canvas: Provides a textured, artistic surface, ideal for high-end displays and artistic presentations.
   Metal: Ensures durability and a modern, sleek appearance, suitable for professional or industrial applications.
   Glass: Adds a premium, elegant touch, allowing for a clear view of the display items while protecting them from dust and damage.
   Acrylic: Combines the clarity of glass with the lightweight and shatter-resistant properties of plastic, suitable for various display environments.
   Wood: Offers a classic, timeless appeal, with options for staining or painting to match different interior designs.
2. Conforming Squares (300): The display board (100) features a grid of conforming squares (300), each meticulously designed to seamlessly accommodate a standard trading card display holder (400). These squares (300) are precisely dimensioned to ensure a snug fit for the holders (400), preventing any lateral or vertical movement once attached. The uniform arrangement of these squares (300) allows for an organized and aesthetically pleasing display layout.
3. Magnets (310): Strategically embedded within the four corners (310a, 310b, 310c, 310d) of each conforming square (300) on the display board (100) are high-strength magnets. These magnets (310) are selected for their strong holding power and reliability, ensuring that the trading card display holders (400) remain securely attached even under varying conditions. The magnets (310) are precisely arranged in such a way that they align perfectly with the screws (410) in the display holders (400), facilitating an effortless and secure magnetic connection.
   Magnet (310) Placement: Each magnet (310) is embedded at precise locations within the corners of the squares (300) to maximize magnetic contact and holding strength.
   Magnet (310) Strength: The magnets (310) are chosen based on their ability to support the weight of the display holders (400) and the enclosed items, ensuring stability and security.
4. Standard Trading Card Display Holders (400): The trading card display holders (400) are designed to provide optimal protection and visibility for trading cards, photographs, and similar collectibles. Each holder (400) is equipped with four screws (410a, 410b, 410c, 410d), one at each corner, which serve as the attachment points for the magnets (310) on the display board (100).
   Holder (400) Material: The holders (400) can be made from durable, transparent materials such as polycarbonate or acrylic, offering clear visibility and protection against environmental damage.
   Screw (410) Design: The screws (410) are designed to be flush with the surface (200) of the holder (400), ensuring a smooth and unobtrusive appearance. The metal composition of the screws (410) ensures a strong magnetic attraction to the magnets (310) in the display board (100).
   Holder (400) Dimensions: The holders (400) are standardized to fit typical trading card sizes, providing a consistent and uniform appearance across the display (100).

Functionality and Use: The innovative design of the magnetic trading card display board allows for a user-friendly and customizable display experience. Users can easily attach and detach the trading card display holders (400) from the board (100), facilitating frequent updates and rearrangements of the displayed items. The magnetic connection ensures that the holders (400) remain securely in place while allowing for quick and easy modifications. This design not only enhances the visual appeal of the displayed items but also provides practical benefits such as easy accessibility and maintenance.

By combining versatility in materials, precise design of conforming squares (300), strategic placement of high-strength magnets (310), and standardized trading card display holders (400), this disclosure addresses the shortcomings of existing display solutions and offers a superior method for showcasing collectibles.

### Differentiating Factors

This disclosure distinguishes itself from existing solutions in several key ways, offering innovative features and benefits that enhance the overall functionality, aesthetic appeal, and user experience of trading card display systems.
1. Compact and Lightweight: The display board is designed to be compact and lightweight, addressing common issues associated with traditional trading card display cases. Traditional cases are often cumbersome, making them difficult to handle, transport, and mount. This disclosure, however, utilizes materials and construction techniques that significantly reduce the overall weight and bulkiness of the display board, making it easy to mount on walls without requiring extensive support or causing damage.
   Reduced Bulk: The display board's slim profile ensures it takes up minimal space, making it ideal for use in various environments, from personal rooms to professional display settings.
   Lightweight Construction: By using materials such as paper, poster board, or acrylic, the display board remains lightweight without compromising on durability, allowing for effortless installation and repositioning.
2. Material Versatility: One of the standout features of this disclosure is its adaptability to various materials, allowing for customization and flexibility in design. This versatility enables the display board to cater to different aesthetic preferences and functional needs, making it suitable for a wide range of applications.
   Paper and Poster Board: Ideal for temporary displays or budget-friendly options, providing an economical solution that is easy to replace or modify.
   Cardboard: Offers a balance between durability and cost-effectiveness, suitable for hobbyists and casual collectors.
   Canvas: Provides a textured, artistic surface that enhances the visual appeal, making it ideal for high-end displays or artistic presentations.
   Metal: Ensures maximum durability and a modern, sleek appearance, suitable for professional or industrial applications where sturdiness is essential.
   Glass: Adds a premium, elegant touch, protecting the displayed items from dust and damage while offering clear visibility.
   Acrylic: Combines the clarity of glass with the lightweight and shatter-resistant properties of plastic, making it versatile for various display environments.
   Wood: Offers a classic, timeless appeal, with options for staining or painting to match different interior designs, providing a warm and traditional look.
3. Ease of Use: The design of the magnetic trading card display board emphasizes user convenience, allowing for effortless rearrangement and accessibility of trading cards. Traditional display systems often require cumbersome processes to add, remove, or reposition items, which can be time-consuming and frustrating.
   Effortless Rearrangement: The magnetic attachment system allows users to easily attach, detach, and rearrange trading cards without the need for additional tools or complicated procedures. This flexibility encourages frequent updates and modifications to the display, keeping it dynamic and engaging.
   High Accessibility: The design ensures that all displayed items remain easily accessible, allowing users to quickly retrieve or replace cards as needed. This is particularly beneficial for collectors who frequently update their collections or participate in trading activities.
4. Simple Installation: Unlike traditional display cases that require nails, screws, or other hardware to mount on walls, this disclosure offers a hassle-free installation process. The display board can be conveniently affixed to a wall using standard tape or 3M tape, eliminating the need for tools and reducing the risk of wall damage.
   Tape Mounting: Standard tape or 3M tape provides a secure and reliable method for mounting the display board on various surfaces, including walls, doors, or other flat surfaces. This method is not only easy to apply but also allows for damage-free removal and repositioning.
   No Tools Required: The elimination of nails, screws, and other hardware simplifies the installation process, making it accessible to users of all skill levels. This ease of installation makes the display board an attractive option for renters or those who prefer not to damage their walls.

Innovative Design and User Benefits: By integrating these differentiating factors, the magnetic trading card display board offers a superior solution for collectors and enthusiasts. The combination of compactness, material versatility, ease of use, and simple installation sets this disclosure apart from existing display systems, providing a user-friendly and aesthetically pleasing option for showcasing trading cards, photographs, and similar collectibles. This innovation not only addresses the limitations of traditional display methods but also enhances the overall experience for users, making it an indispensable addition to any collection.

### BRIEF DESCRIPTION OF DRAWINGS

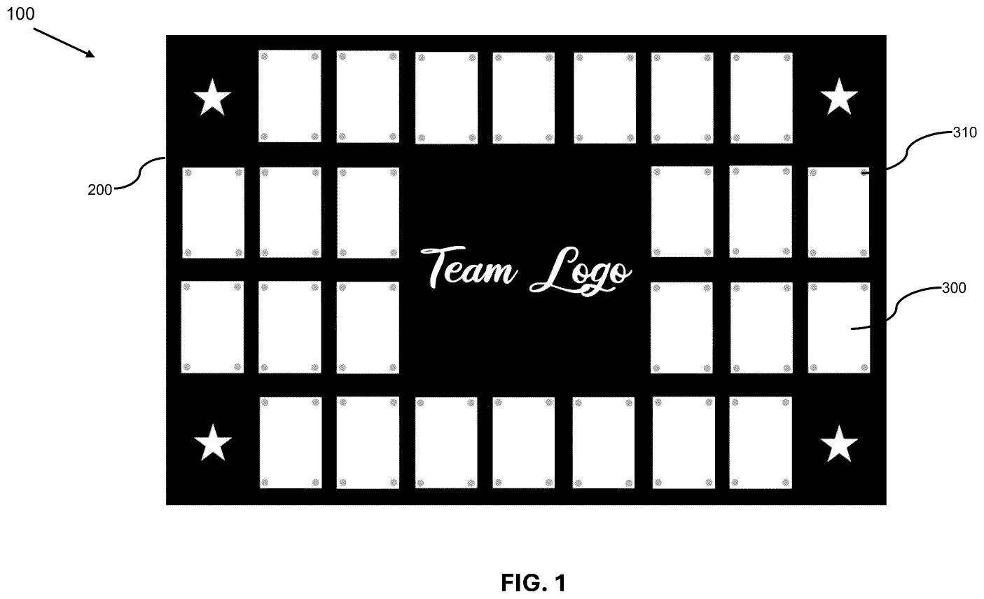

FIG. 1: Overall Design of the Trading Card Display Board
Description: This image depicts one of the possible variations of the trading card display board, showcasing its innovative and user-friendly design. The board is structured with several open squares, each designed to perfectly accommodate a standard individual trading card display holder. Each square is meticulously sized to ensure a snug fit, providing a uniform and organized layout for the display of multiple trading cards.
   Board Material: The display board in this variation is shown made of acrylic, chosen for its clarity and lightweight properties. The board can be customized in various materials, such as paper, cardboard, canvas, metal, glass, or wood, to suit different aesthetic and functional needs.
   Open Squares: The board features a grid of open squares, each precisely dimensioned to fit standard trading card display holders. The uniform arrangement of these squares allows for an organized and visually appealing display.
   Corners of Squares: Each corner of the squares is highlighted to show the strategic placement of the magnets, which are embedded within the board to secure the display holders.

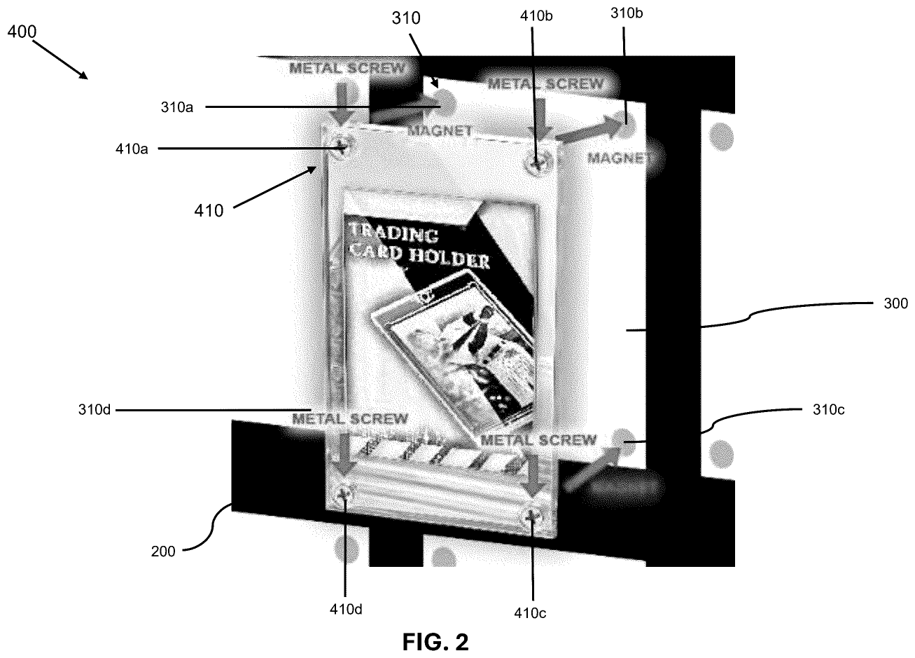

FIG. 2: Magnetic Attachment Mechanism
Description: This image illustrates the innovative magnetic attachment mechanism that allows the standard trading card display holders to be securely and easily mounted on the display board. The image provides a close-up view of how the metal screws from the display holders interact with the magnets embedded in the board.
   Trading Card Display Holder: The holder is shown in detail, highlighting the four (4) metal screws, one at each corner. These screws are designed to be flush with the surface of the holder, ensuring a smooth and unobtrusive appearance.
   Magnet Placement: The image shows the strategic placement of the magnets within the four corners of each square on the display board. The magnets are embedded within the board, ensuring they do not protrude and maintaining a sleek and seamless design.
   Magnetic Connection: The metal screws of the display holder are shown magnetically attached to the magnets in the board's corners. This connection ensures that the holders remain securely in place while allowing for easy attachment and detachment. The strength of the magnets is sufficient to support the weight of the holders and the enclosed trading cards, ensuring stability and security.

### ADDITIONAL DETAILS

### 1. Board Customization

Material Options: The board can be crafted from a variety of materials, including paper for lightweight and temporary displays, poster board for economical solutions, cardboard for sturdiness, canvas for artistic presentations, metal for modern and industrial aesthetics, glass for premium elegance, acrylic for a balance of clarity and durability, and wood for a classic and traditional appeal.
Size Variations: The display board can be manufactured in various sizes to accommodate different quantities of trading cards, providing flexibility for both small and extensive collections.

### 2. Holder Design

Standardized Dimensions: The trading card display holders are designed to fit standard trading card sizes, ensuring compatibility with most trading cards on the market.
Protective Features: The holders are made from durable, transparent materials such as polycarbonate or acrylic, offering protection against dust, dirt, and physical damage while maintaining clear visibility of the cards.

### 3. Ease of Installation

Tape Mounting: The display board can be easily mounted on walls using standard tape or 3M tape, providing a secure and reliable attachment method that does not require nails, screws, or other hardware.
Damage-Free: The tape mounting method ensures that the walls remain undamaged, making the display board an ideal solution for renters or those who prefer not to make permanent modifications to their walls.

With detailed descriptions and images, this patent application highlights the unique features and innovative design of the Magnetic Trading Card Display Board, demonstrating its superiority over existing solutions and emphasizing its practical benefits and aesthetic appeal for collectors and enthusiasts.

1. A Magnetic Trading Card Display Board, comprising:
A display board having multiple conforming squares, each square precisely dimensioned to accommodate a standard individual trading card display holder;
Four magnets strategically embedded at each corner of the conforming squares, designed to align with and magnetically attach to four metal screws located at the corners of the standard trading card display holder;
A secure mounting mechanism provided by the magnets to prevent movement or dislodgement of the trading card display holders while allowing for easy attachment and detachment.

2. The Magnetic Trading Card Display Board of claim 1, wherein the board is fabricated from a material selected from the group consisting of:
Paper, Poster Board, Cardboard, Canvas, Metal, Glass, Acrylic, and Wood.

3. A method for displaying trading cards, comprising the steps of:
Placing a trading card inside a standard individual trading card display holder, ensuring the card is centered and secured;
Aligning the four metal screws located at each corner of the trading card display holder with the four magnets embedded within the corners of an individual square on the magnetic trading card display board;
Magnetically attaching the trading card display holder to the display board by bringing the holder close to the board, allowing the magnets to attract the screws and securely hold the holder in place;
Easily detaching and repositioning the trading card display holders as desired, facilitating the updating and rearrangement of the displayed trading cards without the need for additional tools or complicated procedures.
